(19) United States
(12) Patent Application Publication
(10) Pub. No.: US 2026/0350220 A1
(43) Pub. Date: Nov. 5, 2026

(54) SANITIZATION FOR IMPROVING PRIVACY IN LANGUAGE MODEL INTERACTIONS

(71) Applicant: Dell Products L.P., Round Rock, TX (US)

(72) Inventors: Victor da Cruz Ferreira, Rio de Janeiro (BR); Vinicius Facco Rodrigues, Sao Paulo (BR); Vicente J.P. Amorim, Joao Monlevade (BR)

(73) Assignee: Dell Products L.P., Round Rock, TX (US)

(21) Appl. No.: 19/197,166

(22) Filed: May 2, 2025

(51) Int. Cl. G06F 21/62; G06F 40/166

(52) U.S. Cl. CPC G06F 21/6254; G06F 40/166

(57) ABSTRACT

Techniques are disclosed for sanitization to improve privacy in language model interactions. An example system includes a memory having instructions, and a processor communicatively coupled to the memory and configured to execute the instructions. The instructions can include masking a received text corpus to generate masked text, verifying the masked text to determine a masking ratio for the masked text, the masking ratio measuring a ratio of masked tokens to total tokens in the masked text, using the masking ratio to determine a sanitization process for the masked text, processing the masked text using the sanitization process to generate sanitized text, and outputting the sanitized text.

### FIELD

Example embodiments generally relate to privacy protection and text sanitization in machine learning-based language model interactions. More specifically, at least some embodiments relate to systems, hardware, software, computer-readable media, and methods for anonymizing sensitive information within a text corpus used for training or interacting with language models.

### BACKGROUND

Language models are used in text generation and processing applications. Text sanitization represents a technique for anonymizing sensitive parts of text corpora to prevent direct information exfiltration. Conventional approaches employ Named Entity Recognition and regular expression patterns to identify and mask sensitive information. The process can involve identification of sensitive data identifiers, followed by their masking and/or replacement to achieve anonymization.

### SUMMARY

Techniques are disclosed for sanitization to improve privacy in language model interactions.

In one embodiment, a system includes a memory having instructions, and a processor communicatively coupled to the memory and configured to execute the instructions. The instructions can include masking a received text corpus to generate masked text, verifying the masked text to determine a masking ratio for the masked text, using the masking ratio to determine a sanitization process for the masked text, processing the masked text using the sanitization process to generate sanitized text, and outputting the sanitized text. The masking ratio can measure a ratio of masked tokens to total tokens in the masked text.

In some embodiments, the sanitization process includes an irreversible rewrite of the text corpus to generate the sanitized text. The sanitization process can be the irreversible rewrite when the masking ratio is above a predetermined threshold. The irreversible rewrite can include using a machine learning (ML)-based language model with modified parameters to rephrase the text corpus and anonymize identified sensitive information. The modified parameters can include a model temperature and a prompt. Parameter values for the model temperature and the prompt can be determined using an offline dataset that is cycled during runtime. The masked text can include one or more mask tags and one or more associated mask tokens. The verifying the masked text can further include detecting a likelihood of missed quasi-identifiers in the masked text. Detecting the likelihood of missed quasi-identifiers can include retrieving a token list of masked tokens from the masked text, for each masked token in the token list, determining a similarity list of candidate words similar to the masked token, using an ML-based language model to obtain a top-k list of probable replacements representing top-k highest probabilities for a given candidate token to replace a given mask tag in the masked text, and detecting a presence of a quasi-identifier by comparing the probable replacements with the similarity list. The sanitization process can include a reversible replacement of the masked text to generate the sanitized text. The sanitization process can be the reversible replacement when the masking ratio is below a predetermined threshold. The reversible replacement can include retrieving a token list of masked tokens from the masked text, determining a similarity list of candidate words similar to each masked token in the token list, using a ML-based language model to replace masked tokens from the token list in the masked text with replacement tokens, the replacement tokens being selected to avoid candidate words identified in the similarity list, to obtain replacement masked text, and using the language model to remove quasi-identifiers detected in the replacement masked text and replace a detected quasi-identifier with a replacement value, wherein the replacement tokens and the replacement values are annotated to enable reversal. The instructions can further include, prior to outputting the sanitized text, evaluating the processing using a scoring mechanism to score the masked text and the sanitized text, depending on a result of the scoring mechanism, further processing the masked text by repeating the sanitization process with modified parameters to generate replacement sanitized text, and outputting the replacement sanitized text instead of the sanitized text. The modified parameters can include a model temperature and a prompt. The masking the received text corpus can use a combination of named entity recognition and regular expressions to match predetermined known entities. The masked text can be a chunk of the text corpus.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 discloses aspects of an example sensitive information exfiltration, in accordance with illustrative embodiments.

FIG. 2 discloses aspects of example text generation, in accordance with illustrative embodiments.

FIG. 3 discloses aspects of an example text sanitization system overview, in accordance with illustrative embodiments.

FIG. 4 discloses aspects of an example text sanitization framework overview, in accordance with illustrative embodiments.

FIG. 5 discloses aspects of an example mask verification, in accordance with illustrative embodiments.

FIG. 6 discloses aspects of an example mask algorithm, in accordance with illustrative embodiments.

FIG. 7 discloses aspects of an example quasi-identifier detection, in accordance with illustrative embodiments.

FIG. 8 discloses aspects of an example mask optimization, in accordance with illustrative embodiments.

FIG. 9 discloses aspects of an example irreversible rewrite operation, in accordance with illustrative embodiments.

FIG. 10 discloses aspects of an example reversible replacement operation, in accordance with illustrative embodiments.

FIG. 11 discloses a flowchart of an example method, in accordance with illustrative embodiments.

FIG. 12 discloses aspects of a computing entity configured and operable to perform any of the disclosed methods, processes, and operations, in accordance with illustrative embodiments.

### DETAILED DESCRIPTION

Example embodiments generally relate to privacy protection and text sanitization in machine learning-based language model interactions. More specifically, at least some embodiments relate to systems, hardware, software, computer-readable media, and methods for anonymizing sensitive information within a text corpus used for training or interacting with language models.

Disclosed herein are techniques for text sanitization for improving privacy in language model interactions.

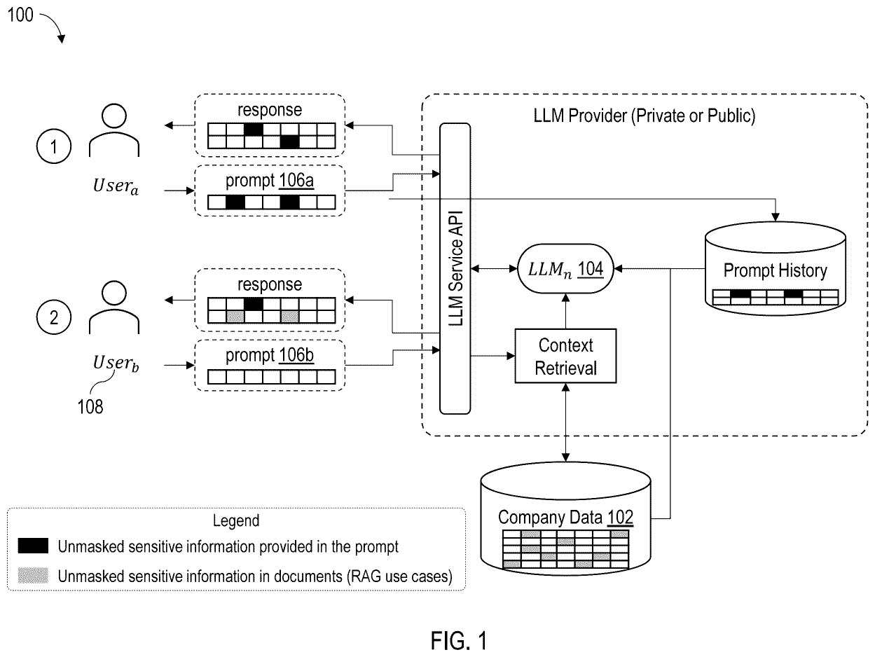

FIG. 1 discloses aspects of an example sensitive information exfiltration 100, in accordance with illustrative embodiments. In particular, FIG. 1 shows sensitive information exfiltration (accidentally or deliberately) by User_{b} 108 due to a lack of data sanitization. Training language models (LMs) usually requires data that can include sensitive information. Protecting such information is an important concern since using sensitive information to train LMs can lead to sensitive information leaks which can be disastrous to businesses.

To overcome this problem, text sanitization represents a technique that can anonymize sensitive parts of a text corpus with the goal of preventing its direct exfiltration from third parties. In general, this is performed by masking specific sentences or words and, optionally, replacing those masks with other words that maintain semantic coherence.

The problem of text sanitization has been present for several years, mostly used for sanitizing medical or legal documents. More recently, with the advent of generative AI (GenAI), the usage of sensitive data for model training or model inference has introduced new use cases that can benefit from anonymization.

If sensitive data 102 is used during training or fine-tuning, the model 104 might leak sensitive data during inference when questioned with specific queries or prompts 106a, 106b (collectively, 106). For inference, a prompt needs to be raw non-encrypted textual information that can lead to possible leakage when using third-party private models such as OpenAI's GPT4, Microsoft's Copilot and others.

Another problem lies in the fact that LMs are more sensitive to text semantic coherence than previous use cases, as non-coherent text is likely to cause bad responses or hallucinations. Therefore, text sanitization techniques need to have smarter replacement techniques and additional validation steps that check for overall coherence.

With the above in mind, technical problems addressed by the disclosed techniques include, but are not limited to, the following:
Identification and anonymization of quasi-identifiers.
Anonymization of sentences while maintaining semantic coherence.
Validation of the anonymization strategy after execution.

The disclosed techniques provide a technical solution to the technical problems discussed herein, including, but not limited to, the following:
A framework for text sanitization that enhances quasi-identifier detection while performing sanitization by keeping text coherence.
A masking verification mechanism that can enhance sensitive data detection by identifying quasi-identifiers.
A sanitization process using an irreversible rewriter process (for example, a text rewriter) and a reversible replacement process (for example, an enhanced guided decoder) that removes quasi-identifiers.
A sanitization score and retry process that controls quality of sanitization.

The disclosed techniques provide a framework for text sanitization that enhances privacy protection in language model interactions. In one implementation, the present framework processes text through the following phases: masking, masking verification, and masking optimization.

In one implementation, the masking phase leverages masking algorithms and frameworks for de-identification, utilizing Named Entity Recognition (NER) and regular expressions with known entities to mask identified text spans.

In one implementation, the masking verification phase performs the following checks:
1. Determining a masking ratio (MR) to evaluate a density of masked tokens in the text
2. Using language models to detect potential quasi-identifiers that may have been missed during initial masking

In one implementation, based on these verification results, the masking optimization phase employs the following optimization approaches:

For high masking ratios or detected quasi-identifiers, a text rewriter performs an irreversible rewrite of the original text using a language model to remove sensitive information while maintaining semantic coherence. The rewritten text undergoes validation using the same masking algorithm to ensure successful sanitization.

Alternatively, an enhanced guided decoder performs a reversible replacement of masked content. This process:
1. Replaces masked tokens with alternative values while avoiding original sensitive information through guided decoding
2. Removes contextual quasi-identifiers
3. Annotates changes to enable reversal when needed
4. Validates results through semantic similarity scoring

Some embodiments of the framework include a scoring mechanism to evaluate sanitization quality. For text rewrites, it verifies no sensitive information remains detectable. For guided decoding, it ensures semantic similarity is maintained while sensitive content is properly obscured. If scoring thresholds are not met, the process repeats with modified parameters until successful sanitization is achieved.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. REFERENCES

Reference is made herein to various documents, which are listed below. These documents are incorporated by this reference herein in their respective entireties for all purposes.
[1] Papadopoulou, Anthi. “Automated Text Sanitization Beyond Named Entities: Resources, Methods, Evaluation.” (2024)
[2] Microsoft Presidio: Data Protection and De-identification SDK. microsoft.github.io/presidio/.
[3] Google Sensitive Data Protection. cloud.google.com/security/products/sensitive-data-protection.
[4] Kan, Zhigang, Linbo Qiao, Hao Yu, Liwen Peng, Yifu Gao, and Dongsheng Li. “Protecting user privacy in remote conversational systems: A privacy-preserving framework based on text sanitization.” arXiv preprint arXiv:2306.08223 (2023).
[5] Jiang, Albert Q., Alexandre Sablayrolles, Arthur Mensch, Chris Bamford, Devendra Singh Chaplot, Diego de las Casas, Florian Bressand et al. “Mistral 7B.” arXiv preprint arXiv:2310.06825 (2023).

### B. CONTEXT FOR ONE OR MORE EMBODIMENTS

The following is a discussion of a context for one or more embodiments. This discussion is not intended to limit the scope of the invention, or the applicability of the embodiments, in any way.

The work [4] describes a conventional prompt sanitization framework that requires examples of sanitization for each data type in the prompt. The prompt sanitization interactively sanitizes one type after another, and it handles semantic inconsistencies by a “reasonability check” mechanism that lacks details. The prompt sanitization mechanism rephrases the text to remove contradictory information; however, the mechanism can rewrite the already replaced mask.

Presidio [2] is a Microsoft solution that employes Named Entity Recognition and regular expression strategies to identify and mask personally identifiable information (PII). The conventional masking strategy is limited to identifying words and replacing the identified words with predefined masks.

### B.1. Text Sanitization

Conventional text sanitization usually starts with identification of sensitive data identifiers, followed by their masking and/or replacement to completely anonymize the data identifiers.

Enhanced identification process of identifiers can involve Named Entity Recognition and regular expression patterns. Some solutions such as Microsoft's Presidio [2] and Google's Sensitive Data Protection [3] have an entire list of entities it can identify.

Although these conventional solutions work well for less complex text spans, the identification of quasi-identifiers slip past detection, allowing the unmasking of sensitive identifiers. As used herein, “quasi-identifiers” refer to identifiers that are not sensitive information, but can be used to infer sensitive information. Quasi-identifier detection is, in most cases, context-based and still considered an open problem.

After identification and masking, replacement can be done using different methodologies that range from static regular expressions to language modeling.

The space of sensitive information removal generally uses different exchangeable nomenclature such as PII, de-identification, anonymization, pseudonymization and differential privacy. Papadopoulou's [1] describes much of this nomenclature.

This description refers to the term “text sanitization” since the term covers a broader spectrum than the other terms. As used herein, “text sanitization” refers to the task of detecting any type of identifying information in a text document and removing or replacing these values with appropriate generalizations.

### B.2. Language Model Guided Decoding

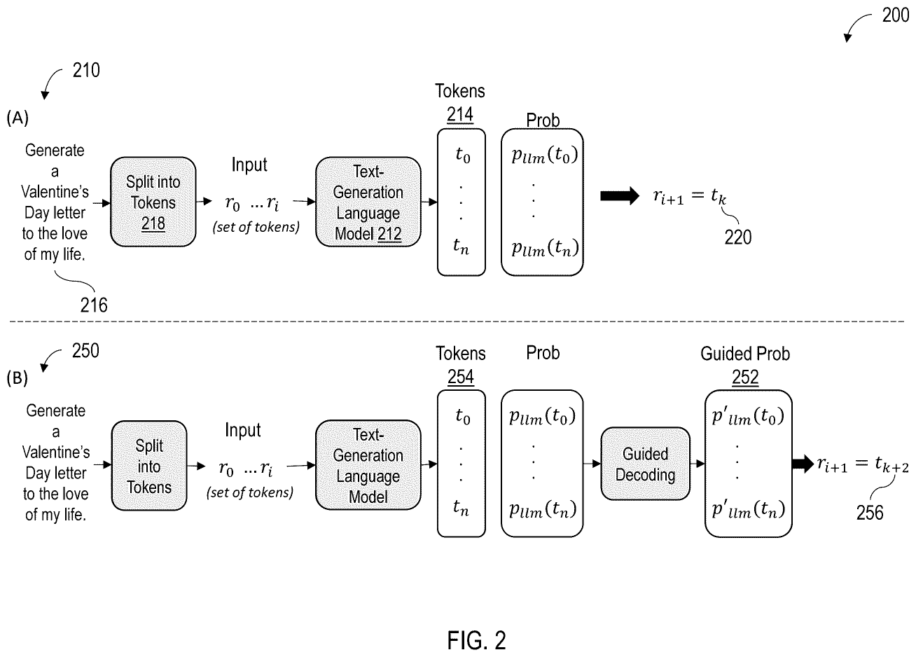

FIG. 2 shows aspects of example text generation 200, in accordance with illustrative embodiments. In particular, FIG. 2(A) shows a conventional text generation 210.

Conventional text generation LMs 212 rely on a transformer architecture to output tokens 214 based on a previously defined token dictionary. Initially, the sentence 216 is transformed into tokens 218 and then embedded. The generated embeddings are processed by the LM that outputs a SoftMax of all available tokens 220.

The SoftMax output 220 can be viewed as a form of classification within the dictionary, as each token is assigned a probability that is used to define the next token. Different strategies involve picking the highest probable token or sampling from the distribution.

In the text generation context, guided decoding involves controlling or modifying the output probabilities of the model to force both token selection, and the overall text generation into a different route.

FIG. 2(B) shows an example 250 where the probabilities 252 are changed, and the output token 254 is modified from the original tₖ to tₖ₊₂ 256.

### C. OVERVIEW OF ASPECTS OF ONE OR MORE EMBODIMENTS

Disclosed herein is a text sanitization framework capable of enhancing conventional masking techniques by detecting context-based quasi-identifiers. One implementation of the present strategy includes two different sanitization techniques that employ a scoring step to evaluate the sanitization process executed. Advantageously, the scoring step at the end of a sanitization minimizes the likelihood of text incoherence and sensitive data leakage.

The present sanitization solution differentiates from conventional prompt sanitization strategies by not requiring the user to define the types of information and examples to sanitize the text. Compared to the present sanitization solution, conventional masking algorithms are limited to predefined classes and word replacement, not focusing on quasi-identifiers and semantic consistency. In one implementation, the disclosed techniques leverage different mechanisms with the help of Large Language Models (LLMs) to detect quasi-identifiers that would otherwise be missed in conventional quasi-identifier identification processes. One use for conventional guided decoding occurs when the system provides guarantees over specific tokens not being selected. The present sanitization solution guarantees text sanitization. Example embodiments leverage guided decoding, in conjunction with a “banned” token list, to ensure sensitive original information within a text span is not selected during text generation.

In one implementation, the present sanitization framework is divided into the following phases: Masking, Masking verification, and Masking optimization.

### C.1. Masking

Example embodiments of this stage leverage existing masking algorithms and frameworks used for de-identification of a received text corpus. In some implementations such frameworks are based on Named Entity Recognition (NER) and regular expressions with a large backlog of known entities and are operable to mask out a given text span of the text corpus on all found entities.

### C.2. Masking Verification

In one implementation, a checking phase receives the masked text span and performs the following checks:
a) Computes a masking ratio

$$MR = \frac{\# masked tokens}{\# total tokens in the text}$$

to determine if there are too many masked tokens in the span. The masking ratio reflects an understanding that a high number of masked tokens adversely impacts sentence meaning as the original text corpus becomes more and more obfuscated. In some embodiments, each application can define its own threshold according to the text chunk sizes.
b) Leverages a language model to determine a likelihood of quasi-identifiers missed during the masking phase.

Example embodiments are configured to use the MR to determine a sanitization process for the masked text. In one implementation, if the MR is above a specified predetermined threshold, the sanitization process is an irreversible rewrite of the text corpus, sometimes referred to herein as a text rewrite or a text sanitization with rewrite. If the MR is below the threshold, but a presence of quasi-identifiers is detected, the sanitization process is a reversible replacement of the masked text, sometimes referred to herein as an enhanced guided decoding or simply a guided decoding. In some embodiments, both sanitization processes have a scoring step at the end that verifies if the sanitization outcome met expectations.

### C.3. Masking Optimization

### C.3.1. Irreversible Rewrite

Example embodiments of the rewrite sanitization leverage an LM to rewrite the original text span so as to remove any identifiers and quasi-identifiers. This process is irreversible, which means if used for retrieval augmented generation-based systems, the user will not be able to revert mentions to their original meaning.

In one implementation, at the scoring step, the present sanitization executes the same de-identification algorithm as in the masking phase, but on the rewritten text span. If there are no mask tokens or the mask tokens' original values cannot be found, the sanitization is determined to be successful. Otherwise, the present sanitization retries the rewrite step with modified model parameters.

### C.3.2. Reversible Replacement

In one implementation, the guided decoding sanitization receives the masked text chunk (for example, the masked sentence) from the received text corpus and leverages a LM to replace the masked tokens with other values. Some embodiments of the present sanitization guarantee distinct values from the original values by channeling the generation processes through a guided decoding that considers a list of previous words to be avoided.

In one implementation, after the mask token replacement, the present sanitization further uses the LM to remove any inconsistencies so as to remove context-based quasi-identifiers. Some embodiments annotate the changes and removals so they can be reversed. For example, if the present sanitization modified “John” to “Paul,” any mentions of “Paul” can be reverted to “John” using the disclosed framework.

In one implementation, at the scoring step, the disclosed techniques perform a semantic comparison between the sanitized sentence and the original one. If the score is determined to be too low, this indicates the text span was probably rewritten too much, and the present sanitization proceeds to retry with modified parameters.

### D. DETAILED DISCUSSION OF ASPECTS OF ONE OR MORE EMBODIMENTS

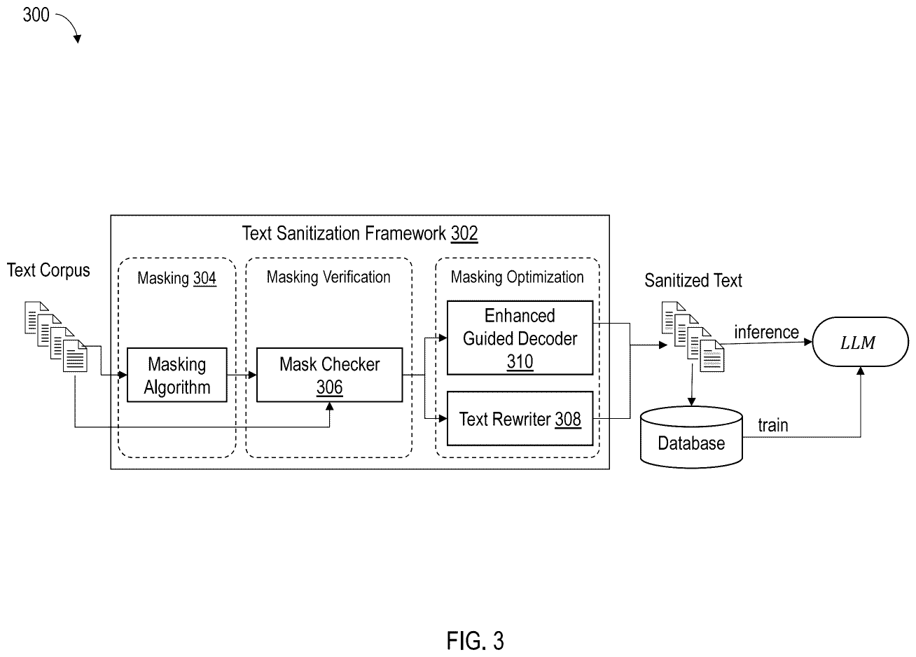

Disclosed herein is a text sanitization framework capable of anonymizing sensitive information, including quasi-identifiers. FIG. 3 shows aspects of an example overview 300 of the text sanitization system. In particular, FIG. 3 shows an example flow of a text sanitization framework 302. Example embodiments of the framework are configured to mask 304 existing sensitive entities and use contextual cues to identify missed quasi-identifiers. Based on this check 306, example embodiments are configured to perform a sanitization process. The sanitization process can be an irreversible rewrite (for example, a text rewriter 308) or a reversible replacement (for example, an enhanced guided decoder 310). In both cases, some embodiments evaluate the applied anonymization strategy using different scoring mechanisms and redo the replacement or rewrite if needed.

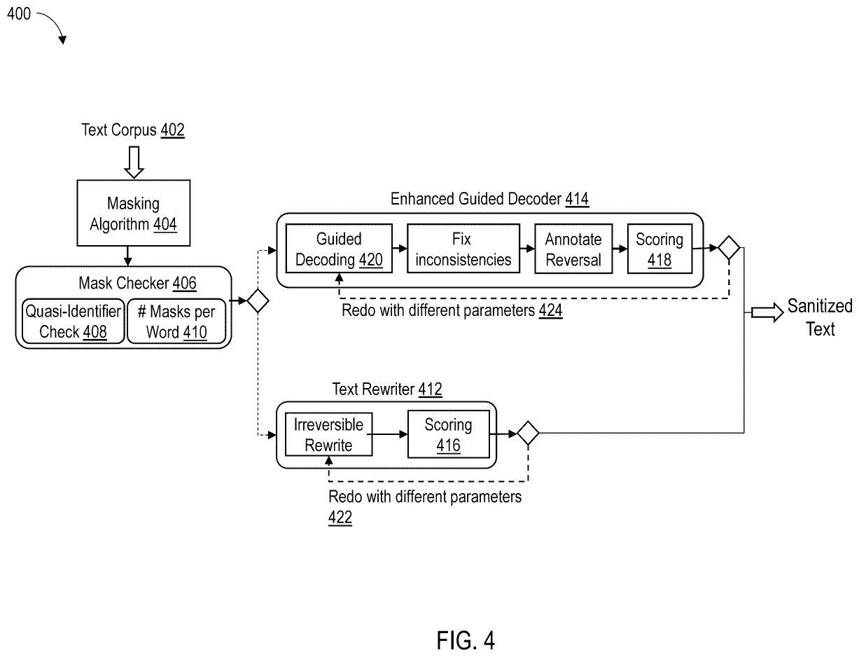

FIG. 4 shows aspects of an overview of an example text sanitization framework 400, in accordance with illustrative embodiments.

Example embodiments start by receiving a text corpus 402. In some embodiments, the text corpus is split into smaller chunks. In further embodiments, the chunks are sentences of the text corpus. Example embodiments process the text chunks using a masking algorithm 404 configured to detect sensitive entities, thereby masking out the sensitive entities so as to generate masked text.

In one implementation, the masked text proceeds through a mask checker 406 configured to verify if there are possible quasi-identifiers 408 that were not masked, or if the sentence has too many masked tokens 410.

In one implementation, depending on the output of the mask checker 406, the present framework 400 is configured to:
rewrite 412 the entire original chunk to remove any sensitive information; or
perform an enhanced guided decoding 414 to replace the masks with meaningful values.

Some embodiments calculate a score using a scoring mechanism 416, 418 depending on the sanitization process used:
a) Enhanced Guided Decoding 414: the sanitization framework 400 embeds the original chunk and the sanitized chunk and determines a similarity measure as the score. In some embodiments, the similarity measure is cosine similarity. If the similarity is low, then the decoding 420 was successful.
b) Text Rewriter 412: the sanitization framework 400 runs the same masking algorithm 404 over the rewritten chunk to check how many masks are added as the score. If the number of masked tokens is equal to zero, then the rewrite was successful.

In one implementation, if the score is determined to be low, the sanitization framework 400 is configured to redo 422, 424 the enhanced guided decoding 414 or text rewrite 412 with modified parameters. Otherwise, the sanitization framework assumes the text chunk was successfully sanitized.

The following sections discuss masking the following sentence to highlight how the sanitization framework 400 morphs the original sentence into a sanitized one: “Victor travelled to Paris and had his dinner near the Eiffel Tower.” In one implementation, the present system uses:
Microsoft Presidio [2] as an example masking algorithm 404; and
Mistral 7B [5] as an example mask checker 406, text rewriter 412, and enhanced guided decoder 414. In illustrative embodiments, an off-the-shelf Mistral deployment hosted on-premises can be used, since otherwise using the model through third-party access (for example, via cloud-based or service-based access) would run counter to the purpose of sanitizing a given text corpus in the first place.

In example embodiments, a service can implement the present sanitization techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations.

In some implementations, the service is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

### D.1. Masking Verification

In one implementation, after receiving the text corpus and splitting the corpus into chunks, the present system is configured to apply a masking algorithm that masks a given chunk. For example, Microsoft Presidio uses a combination of NER and regular expressions to hide sensitive information using different mask tokens. In some embodiments, the present sanitization defines two checks that guide the framework decision if the system should rewrite the entire sentence or replace only the masked values.

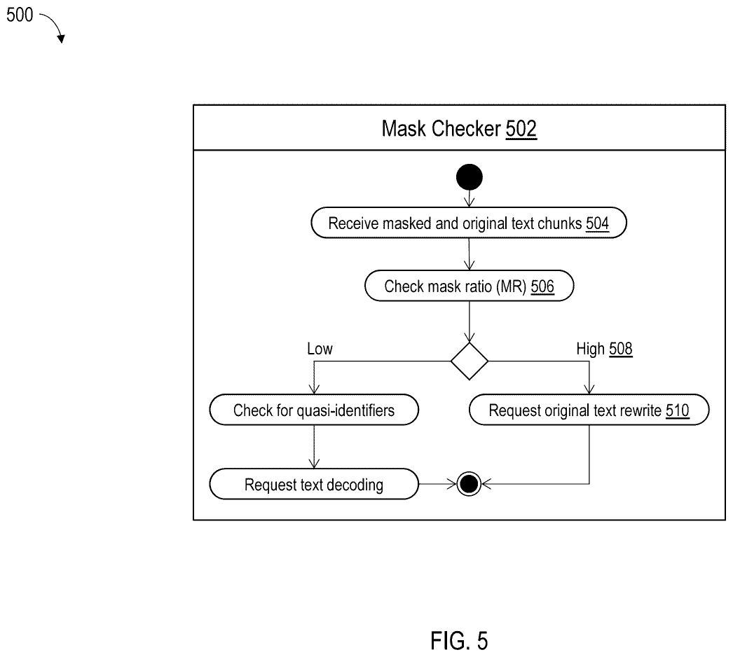

FIG. 5 shows aspects of an example mask verification 500, in accordance with illustrative embodiments. In particular, FIG. 5 shows an example mask checker 502 activity diagram demonstrating a processing flow upon receiving the masked text 504 from the masking algorithm.

### D.1.1. Masking Ratio

In one implementation, the present sanitization checks the masking ratio 506. If the MR per text chunk is determined to be too high 508, this reflects that the chunk was masked in excess. Phrased differently, most of the resulting text is composed substantially of stop words. As a result, simply replacing the masked tokens is likely to disrupt sentence coherence. If this check is true, the framework performs an irreversible rewrite 510 (for example, a full chunk rewrite). This irreversible rewrite is discussed in further detail herein.

### D.1.2. Quasi-Identifier Detection

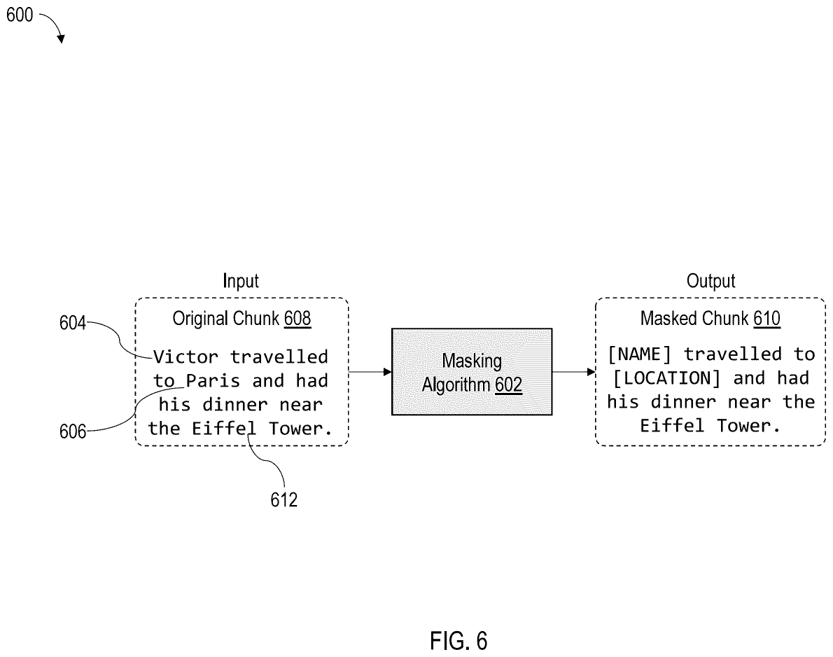

FIG. 6 shows aspects of an example mask algorithm 600, in accordance with illustrative embodiments. In particular, FIG. 6 shows a masking algorithm 602 configured to process an original chunk 608 to generate a masked chunk 610.

Example embodiments of the masked chunk 610 include mask tags and mask tokens. The mask tokens represent values in the original chunk 608 to be masked, such as “Victor” and “Paris.” The mask tags indicate types of the tokens to be masked from the original chunk, such as “[NAME]” and “[LOCATION].”

In the example masking shown in FIG. 6, the masking algorithm 602 successfully masks a name 604 and a location 606 in the original chunk 608. In some embodiments, the masking algorithm is configured to use a combination of Named Entity Recognition and regular expressions for pattern matching of predetermined known entities. In one implementation, the masking algorithm is Microsoft Presidio.

However, it should also be appreciated that “Eiffel Tower” 612 is a quasi-identifier because the token might be used to infer the location back to “France.” Example embodiments of the mask checker are configured to detect this situation. In one implementation, if the mask checker detects possible quasi-identifiers, the present framework is configured to perform an enhanced guided decoder operation, as described in further detail herein. Additionally, even if no quasi-identifiers are detected, the present framework is still configured to perform the enhanced guided decoding, to replace the masked tokens with semantic equivalents.

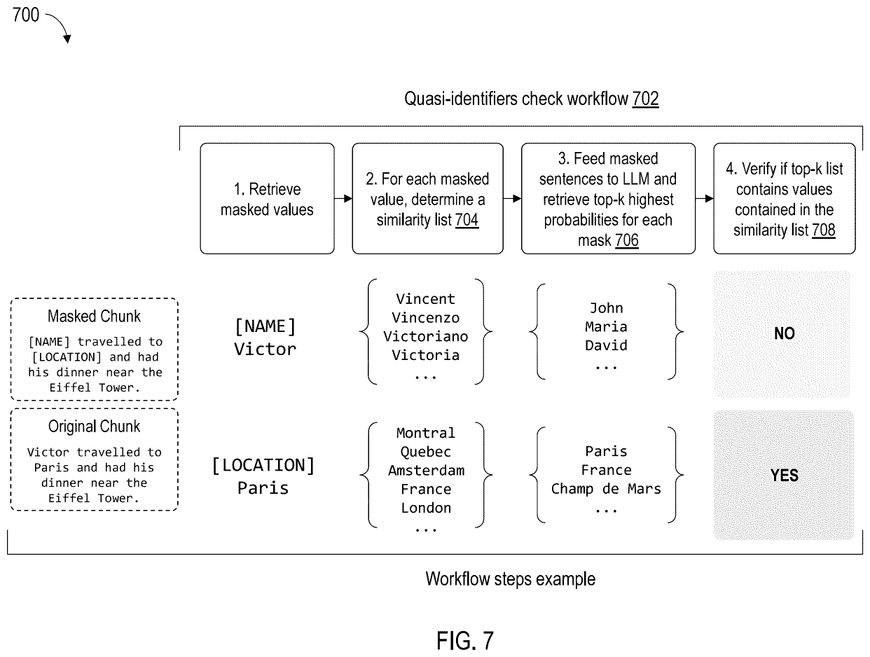

FIG. 7 shows aspects of an example quasi-identifier detection 700, in accordance with illustrative embodiments. Because quasi-identifiers are context-based, in one implementation the present sanitization leverages a large language model for quasi-identifier detection. In particular, FIG. 7 shows an example workflow 702 performed by the mask checker to detect quasi-identifiers.

In one implementation, for every masked token, the present framework determines a list of words similar to the original masked tokens 704. This list is referred to herein as the similarity list. The similarity list can be determined in different ways depending on the use case. For example, if the present framework is deployed internal to the company, a vector database can be used to store and retrieve similar contents. For high-technology computer companies specifically, the database could store product line names and specs. For other more general names or values, a web query to a search engine or requesting the same model for similar values could be alternatives. Following the example, for “Paris” the similarity list would include a list of states or other countries related to France.

In one implementation, afterwards, the present framework is configured to feed the masked sentence to the LLM 706 and ask the LLM to generate a list of probable replacements to replace each mask tag. For each individual masked token, given the model prediction probabilities for the word it can choose to replace, the present framework is configured to evaluate the top-k highest probability words.

In one implementation, if those top-k probable replacements match one or multiple of the top-k words in the similarity list 708, this is an indication that a quasi-identifier slipped past detection by the masking algorithm. FIG. 7 shows that the model is highly likely to replace the mask tag “[LOCATION]” with the token “Paris” or “France.” This result shows that there remains enough context information in the remaining unmasked sentence that allows for the model to de-mask that value back to the original.

### D.2. Masking Optimization

In example embodiments, at this stage, depending on the output of the mask checker the present sanitization is configured to perform either a complete irreversible chunk rewrite or a reversible replacement of the masked contents.

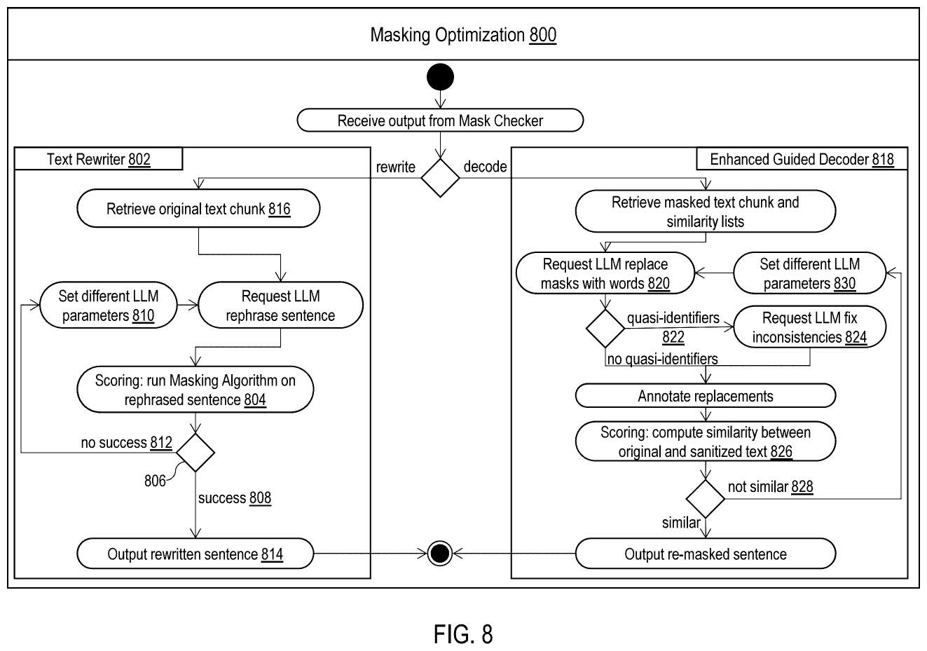

FIG. 8 shows aspects of an example mask optimization 800, in accordance with illustrative embodiments. In particular, FIG. 8 shows an activity diagram demonstrating example processing steps.

### D.2.1. Irreversible Rewrite

Example embodiments of the text rewriter 802 are configured to use the original text chunk 816 instead of the masked chunk. However, in one implementation the text rewriter is configured to use different mask tags to indicate to the model the text tokens that should be replaced.

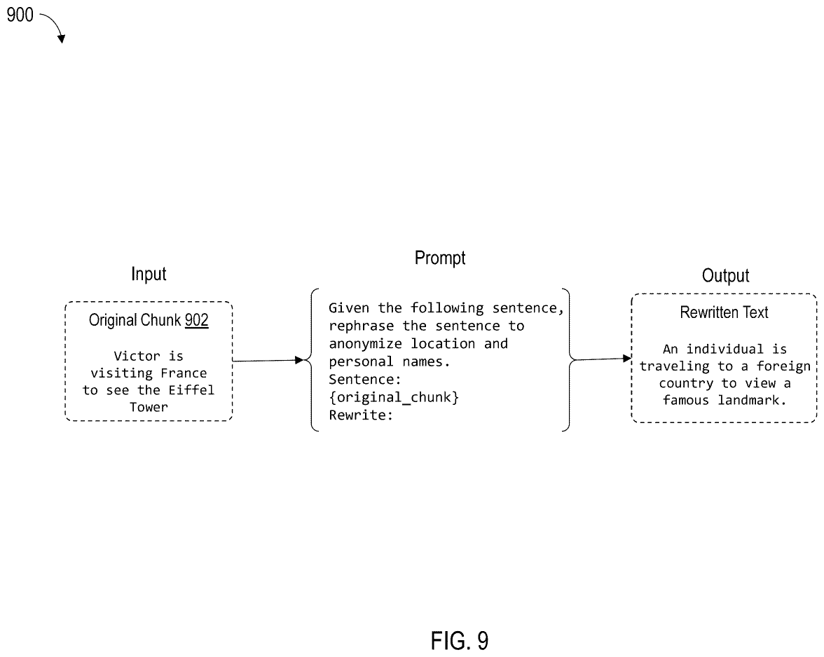

FIG. 9 shows aspects of an example irreversible rewrite operation 900, in accordance with illustrative embodiments. In particular, FIG. 9 shows an example where a large language model is configured to rephrase the text chunk 902 to anonymize person and locations. The LLM successfully anonymizes the text while still maintaining coherence.

With reference to FIG. 8, in one implementation, at the scoring step 804, the masking optimization 800 is configured to run the same masking algorithm over the rewritten chunk to validate whether the rewrite was successful 806. In some embodiments, the masking algorithm used is Presidio. If the masking algorithm is unable to find anything to mask or whatever it masks does not hold the same word as the original sentence, the masking optimization 800 considers the text rewriting 802 to be a successful sanitization process (success 808). Otherwise, the masking optimization 800 is configured to perform another rewrite with modified model parameters 810 (no success 812).

In one embodiment, the modified parameters include varying hyperparameters of the model, such as the model temperature, or modifying the prompt processed by the model. In further embodiments, these prompts and temperature values can be identified empirically through an offline dataset that can be cycled at runtime. After the prompts and temperature values are exhausted, the mask optimization 800 can select the solution with the smallest number of masked tokens as the output rewritten sentence 814.

It should be noted that this text rewriter procedure 802 is irreversible, where the output 814 (sanitized text) cannot be reverted to the original content if needed, as the sanitized text may lose its original format and properties. Furthermore, the text rewriter procedure may destroy important information required for specific use cases. For example, if the goal is to fine-tune a recommendation network for travel, keeping actual names of locations may be required. In some embodiments, for such use cases creation of different prompts or only using the enhanced guided decoder 818 is advised.

### D.2.2. Reversible Replacement

In one implementation, if the mask checker returned a low MR, the mask optimization 800 is configured to request a language model to replace the masked tokens with other words 820. Additionally, if quasi-identifiers were detected (quasi-identifiers 822), the enhanced guided decoder process 818 is configured to remove and replace the quasi-identifiers, as described in further detail herein. To make sure the enhanced guided decoder does not replace the mask tags with the original values or too similar content, the enhanced guided decoder is configured to leverage the similarity list from the mask checker (Section D.1) to perform guided decoding. In particular, the similarity list works as a list of banned values that LLM is not allowed to predict, forcing the LLM to sample from other probabilities.

In one implementation, the enhanced guided decoder 818 is configured to perform a second pass where the same LLM is used to fix any inconsistencies found 824 (quasi-identifier removal). This process works better for smaller text chunks and in some embodiments can be enhanced by using chain-of-thought where the LLM is configured to reflect on available inconsistencies before replacing them.

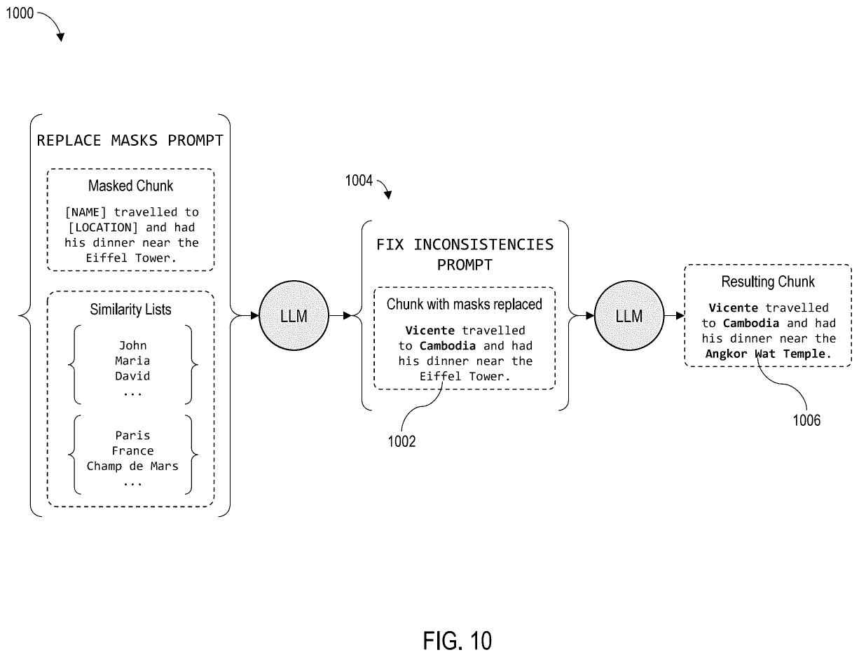

FIG. 10 shows aspects of an example reversible replacement operation 1000, in accordance with illustrative embodiments. In particular, FIG. 10 shows an example of the enhanced guided decoder process described herein.

FIG. 10 shows that the “Eiffel Tower” term 1002 is gone after this second pass 1004, being replaced by “Angkor Wat Temple” 1006 from Cambodia. Example embodiments are configured to annotate this replacement so that all changes can be reversed if needed. Advantageously, this annotation is useful if the document or text corpus is used as context for a third-party private model inference, allowing the user to revert all replacement mentions back to the original value.

With reference to FIG. 8, at the scoring step 826, the enhanced guided decoder 818 is configured to perform a verification if the sanitization was successful. In one implementation, to perform this check, the enhanced guided decoder is configured to embed the original chunk and the sanitized chunk and perform a similarity computation 826. In some embodiments, the similarity computation is cosine similarity. In further embodiments, the enhanced guided decoder is configured to use a predetermined lower bound threshold that determines if the validation was successful. In still further embodiments, the threshold hyperparameter can depend on the text span size, so the threshold could be defined according to the application. For example, for smaller text span sizes, the bound can be lower since changes to the text span due to sanitization will cause higher dissimilarities.

If the sentence is not similar at all to the original chunk 828, this result indicates the LLM probably rewrote too much of the sentence, therefore the enhanced guided decoder 818 is configured to retry with modified parameters 830. In one implementation, the parameter variations are similar to the ones described in connection with the text rewriter 802, such as temperature and different prompts.

Advantageously, it should be noted that the enhanced guided decoder 818 does not need to verify if the previous sensitive tokens found by the masking algorithm are present in the sanitized text because the enhanced guided decoder guarantees the previous sensitive tokens will not be selected.

### E. EXAMPLE METHODS

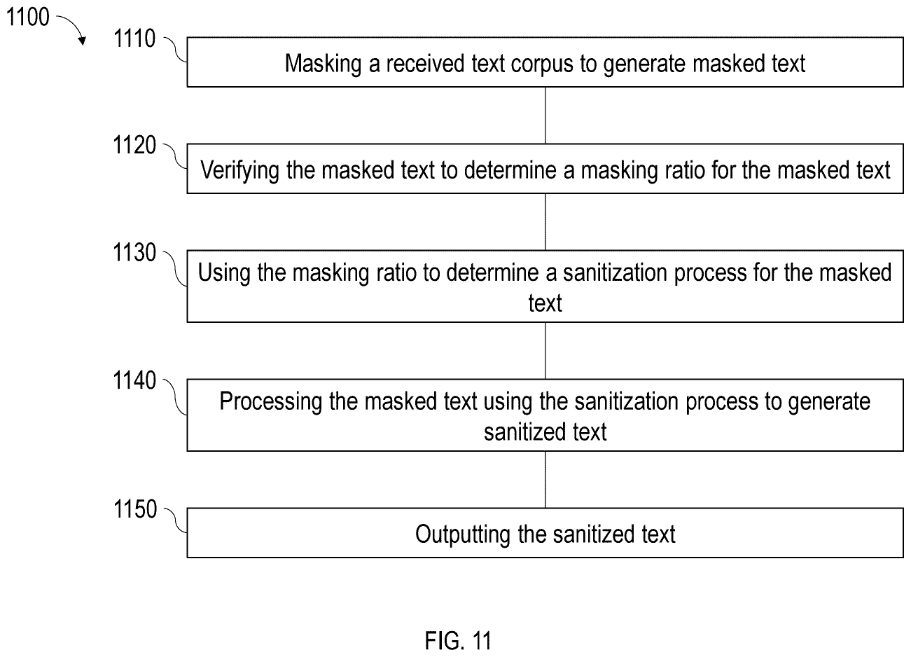

FIG. 11 shows a flowchart of an example method 1100, in accordance with illustrative embodiments. In example embodiments, the method 1100 allows for improved issue handling by identifying similar historical issues as references for a given issue.

In some embodiments, the method 1100 can be performed by the sanitization solution 302, 400 (FIGS. 3, 4).

In example embodiments, the method 1100 includes masking a received text corpus to generate masked text (step 1110). In some embodiments, the masked text includes one or more mask tags and one or more associated mask tokens. In some embodiments, masking the received text corpus uses a combination of Named Entity Recognition and regular expressions to match predetermined known entities. In some embodiments, the masked text is a chunk of the text corpus.

In example embodiments, the method 1100 includes verifying the masked text to determine a masking ratio for the masked text (step 1120). The masking ratio can measure a ratio of masked tokens to total tokens in the masked text. In some embodiments, the verifying the masked text further includes detecting a likelihood of missed quasi-identifiers in the masked text. The quasi-identifiers can indicate identifiers that are not sensitive information but are usable to infer sensitive information. In further embodiments, the detecting the likelihood of missed quasi-identifiers includes retrieving a token list of masked tokens from the masked text, and for each masked token in the token list, determining a similarity list of candidate words similar to the masked token, using an ML-based language model to obtain a top-k list of probable replacements representing top-k highest probabilities for a given candidate token to replace a given mask tag in the masked text, and detecting a presence of a quasi-identifier by comparing the probable replacements with the similarity list.

In example embodiments, the method 1100 includes using the masking ratio to determine a sanitization process for the masked text (step 1130).

In some embodiments, the sanitization process includes an irreversible rewrite of the text corpus to generate the sanitized text. In further embodiments, the sanitization process is the irreversible rewrite when the masking ratio is above a predetermined threshold. In some embodiments, the irreversible rewrite includes using an ML-based language model with modified parameters to rephrase the text corpus and anonymize identified sensitive information. In further embodiments, the modified parameters include a model temperature and a prompt. In still further embodiments, parameter values for the model temperature and the prompt are determined using an offline dataset that is cycled during runtime.

In some embodiments, the sanitization process includes a reversible replacement of the masked text to generate the sanitized text. In further embodiments, the sanitization process is the reversible replacement when the masking ratio is below a predetermined threshold. In further embodiments, the reversible replacement includes retrieving a token list of masked tokens from the masked text, determining a similarity list of candidate words similar to each masked token in the token list, using a ML-based language model to replace masked tokens from the token list in the masked text with replacement tokens, the replacement tokens being selected to avoid candidate words identified in the similarity list, to obtain replacement masked text, and using the language model to remove quasi-identifiers detected in the replacement masked text and replace a detected quasi-identifier with a replacement value. The replacement tokens and the replacement values can be annotated to enable reversal.

In example embodiments, the method 1100 includes processing the masked text using the sanitization process to generate sanitized text (step 1140).

In example embodiments, the method 1100 includes outputting the sanitized text (step 1150).

In some embodiments, the method 1100 further includes evaluating the processing using a scoring mechanism to score the masked text and the sanitized text, depending on a result of the scoring mechanism, further processing the masked text by repeating the sanitization process with modified parameters to generate replacement sanitized text, and outputting the replacement sanitized text instead of the sanitized text. In some embodiments, the modified parameters include a model temperature and a prompt.

While the various steps in the example method 1100 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 1100 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### F. EXAMPLE PROCESSING PLATFORMS

At least portions of the present sanitization system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present sanitization system. For example, containers can be used to implement respective processing devices providing compute and/or storage services of a cloud-based system. Again, containers may be used in combination with other virtualization infrastructure such as virtual machines implemented using a hypervisor.

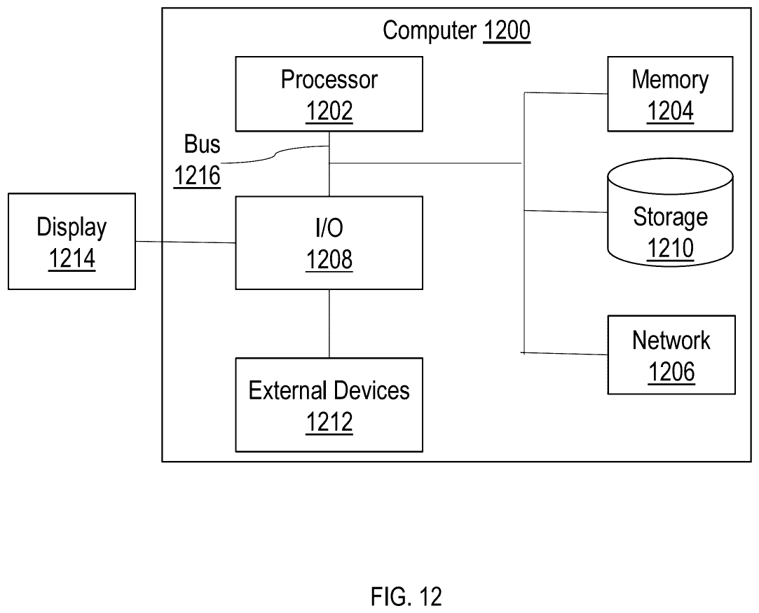

Illustrative embodiments of processing platforms will now be described in greater detail with reference to FIG. 12. Although described in the context of the present sanitization system, these platforms may also be used to implement at least portions of other information processing systems in other embodiments.

FIG. 12 illustrates aspects of a computing device or a computing system in accordance with example embodiments. The computer 1200 is shown in the form of a general-purpose computing device. Components of the computer may include, but are not limited to, one or more processors or processing units 1202, a memory 1204, a network interface 1206, and a bus 1216 that communicatively couples various system components including the system memory and the network interface to the processor.

The bus 1216 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1200 typically includes a variety of computer-readable media. Such media may be any available media that is accessible by the computer system, and such media includes both volatile and non-volatile media, removable and non-removable media.

The memory 1204 may include computer system readable media in the form of volatile memory, such as random-access memory (RAM) and/or cache memory. The computer system may further include other removable/non-removable, volatile/non-volatile computer system storage media. By way of example only, the storage system 1210 may be provided for reading from and writing to a non-removable, non-volatile magnetic media (not shown and typically called a “hard drive”) in accordance with the present sanitization techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 1216 by one or more data media interfaces. As has been depicted and described in connection with FIGS. 1-11, the memory may include at least one computer program product having a set (e.g., at least one) of program modules that are configured to carry out the functions of the embodiments as described herein.

The computer 1200 may also include a program/utility, having a set (at least one) of program modules, which may be stored in the memory 1204 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 1200 may also communicate with one or more external devices 1212 such as a keyboard, a pointing device, a display 1214, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 1208. Still yet, the computer system may communicate with one or more networks such as a local area network (LAN), a general wide area network (WAN), and/or a public network (e.g., the Internet) via the network adapter 1206. As depicted, the network adapter communicates with the other components of the computer system via the bus 1216. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-12, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
a memory including instructions; and
a processor communicatively coupled to the memory and configured to execute the instructions, the instructions including:
masking a received text corpus to generate masked text;
verifying the masked text to determine a masking ratio for the masked text, the masking ratio measuring a ratio of masked tokens to total tokens in the masked text;
using the masking ratio to determine a sanitization process for the masked text;
processing the masked text using the sanitization process to generate sanitized text; and
outputting the sanitized text.

2. The system of claim 1, wherein the sanitization process includes an irreversible rewrite of the text corpus to generate the sanitized text.

3. The system of claim 2, wherein the sanitization process is the irreversible rewrite when the masking ratio is above a predetermined threshold.

4. The system of claim 2, wherein the irreversible rewrite includes using a machine learning (ML)-based language model with modified parameters to rephrase the text corpus and anonymize identified sensitive information.

5. The system of claim 4, wherein the modified parameters include a model temperature and a prompt.

6. The system of claim 5, wherein parameter values for the model temperature and the prompt are determined using an offline dataset that is cycled during runtime.

7. The system of claim 1,
wherein the masked text includes one or more mask tags and one or more associated mask tokens;
wherein the verifying the masked text further includes detecting a likelihood of missed quasi-identifiers in the masked text, the quasi-identifiers indicating identifiers that are not sensitive information but are usable to infer sensitive information; and
wherein the detecting the likelihood of missed quasi-identifiers includes:
retrieving a token list of masked tokens from the masked text;
for each masked token in the token list:
determining a similarity list of candidate words similar to the masked token;
using an ML-based language model to obtain a top-k list of probable replacements representing top-k highest probabilities for a given candidate token to replace a given mask tag in the masked text; and
detecting a presence of a quasi-identifier by comparing the probable replacements with the similarity list.

8. The system of claim 1, wherein the sanitization process includes a reversible replacement of the masked text to generate the sanitized text.

9. The system of claim 8, wherein the sanitization process is the reversible replacement when the masking ratio is below a predetermined threshold.

10. The system of claim 8, wherein the reversible replacement includes:
retrieving a token list of masked tokens from the masked text;
determining a similarity list of candidate words similar to each masked token in the token list;
using a ML-based language model to replace masked tokens from the token list in the masked text with replacement tokens, the replacement tokens being selected to avoid candidate words identified in the similarity list, to obtain replacement masked text; and
using the language model to remove quasi-identifiers detected in the replacement masked text and replace a detected quasi-identifier with a replacement value, wherein the replacement tokens and the replacement values are annotated to enable reversal.

11. The system of claim 1, wherein the instructions further include:
prior to outputting the sanitized text, evaluating the processing using a scoring mechanism to score the masked text and the sanitized text;
depending on a result of the scoring mechanism, further processing the masked text by repeating the sanitization process with modified parameters to generate replacement sanitized text; and
outputting the replacement sanitized text instead of the sanitized text.

12. The system of claim 11, wherein the modified parameters include a model temperature and a prompt.

13. The system of claim 1, wherein masking the received text corpus uses a combination of named entity recognition and regular expressions to match predetermined known entities.

14. The system of claim 1, wherein the masked text is a chunk of the text corpus.

15. A method comprising:
masking a received text corpus to generate masked text;
verifying the masked text to determine a masking ratio for the masked text, the masking ratio measuring a ratio of masked tokens to total tokens in the masked text;
using the masking ratio to determine a sanitization process for the masked text;
processing the masked text using the sanitization process to generate sanitized text; and
outputting the sanitized text.

16. The method of claim 15, wherein the sanitization process includes an irreversible rewrite of the text corpus to generate the sanitized text when the masking ratio is above a predetermined threshold.

17. The method of claim 16, wherein the irreversible rewrite includes using an ML-based language model with modified parameters to rephrase the text corpus and anonymize identified sensitive information.

18. The method of claim 15, wherein the sanitization process includes a reversible replacement of the masked text to generate the sanitized text when the masking ratio is below a predetermined threshold.

19. The method of claim 18, wherein the reversible replacement includes:
retrieving a token list of masked tokens from the masked text;
determining a similarity list of candidate words similar to each masked token in the token list;
using an ML-based language model to replace masked tokens from the token list in the masked text with replacement tokens, the replacement tokens being selected to avoid candidate words identified in the similarity list, to obtain replacement masked text; and
using the language model to remove quasi-identifiers detected in the replacement masked text and replace a detected quasi-identifier with a replacement value, wherein the replacement tokens and the replacement values are annotated to enable reversal.

20. A non-transitory processor-readable storage medium having stored thereon program code of one or more software programs, wherein the program code when executed by at least one processing device causes the at least one processing device to perform the following steps:
masking a received text corpus to generate masked text;
verifying the masked text to determine a masking ratio for the masked text, the masking ratio measuring a ratio of masked tokens to total tokens in the masked text;
using the masking ratio to determine a sanitization process for the masked text;
processing the masked text using the sanitization process to generate sanitized text; and
outputting the sanitized text.
